(19) United States
(12) Patent Application Publication
(10) Pub. No.: US 2008/0030974 A1
(43) Pub. Date: Feb. 7, 2008

(54) LED-Based Illumination System

(76) Inventor: Nayef M. Abu-Ageel, Haverhill, MA (US)

Correspondence Address: MICHAEL K. LINDSEY;GAVRILOVICH, DODD & LINDSEY, LLP, 3303 N. SHOWDOWN PL., TUCSON, AZ, 85749, US

(21) Appl. No.: 11/833,222

(22) Filed: Aug. 2, 2007

Related U.S. Application Data
(60) Provisional application No. 60/821,195, filed on Aug. 2, 2006.

(51) Int. Cl. F21V 7/04

(52) U.S. Cl. 362/19; 362/555

(57) ABSTRACT

An illumination system includes one or more extraction optical elements to efficiently extract light from light emitting diodes (LEDs) by reducing light losses within the LED structure. Micro-element optical plates can also be included in the system to provide control over the spatial distribution of light in terms of intensity and angle.

### CROSS-REFERENCE TO RELATED APPLICATIONS

This application claims the benefit of U.S. Provisional Application No. 60/821,195 filed on Aug. 2, 2006, which is incorporated herein by reference.

The following patent applications are also hereby incorporated herein by reference:
(1) U.S. patent application Ser. No. 10/458,390 filed on Jun. 10, 2003, titled “Light Guide Array, Fabrication Methods, and Optical System Employing Same”;
(2) U.S. patent application Ser. No. 11/066,605, titled “Compact Polarization Conversion System for Optical Displays,” Attorney Docket No. 00024.0005.NPUS00, filed on Feb. 25, 2005;
(3) U.S. patent application Ser. No. 11/066,616, titled “Compact Projection System Including A Light Guide Array,” Attorney Docket No. 00024.0006.NPUS00, filed on Feb. 25, 2005;
(4) U.S. patent application Ser. No. 11/067,591, titled “Light Recycler and Color Display System Including Same,” Attorney Docket No. 00024.0007.NPUS00, filed on Feb. 25, 2005;
(5) U.S. Patent Application No. 60/639,925, titled “Light Recovery system and Display Systems Employing Same”, Attorney Docket No. 00024.0008.PZUS00, filed on Dec. 22, 2004;
(6) U.S. Patent Application No. 60/719,155, titled “Compact Light Collection Systems”, Attorney Docket No. 00024.0009.PZUS00, filed on Sep. 21, 2005;
(7) U.S. patent application Ser. No. 11/232,310, titled “Method and Apparatus for Reducing Laser Speckle”, Attorney Docket No. 00024.0010.NPUS00, filed on Sep. 21, 2005;
(8) U.S. Patent Application No. 60/719,109, titled “Light Extraction in LEDs using Micro-Optical Elements”, Attorney Docket No. 00024.0011.PZUS00, filed on Sep. 21, 2005; and
(9) U.S. Patent Application No. 60/806,770, titled “Highly Efficient Light Emitting Diodes”, Attorney Docket No. 00024.0012.PZUS00, filed on Jul. 8, 2006.

### TECHNICAL FIELD

The invention relates generally to light emitting diodes, and more particularly, to light emitting diode (LED) based illumination and projection systems.

### BACKGROUND

Light emitting diodes (LEDs) are considered attractive light sources for various applications such as such as traffic signals, displays, automobile headlights and taillights and conventional indoor lighting. However, in some applications, light emitted from an LED is not completely utilized. For example, etendue-limited projection display systems utilize only a portion of the light emitted from the LED and the remainder of the light is wasted. These projection systems are usually limited by the area of the display panel and/or the cone angle of the projection lens.

One known method for collimating and uniformizing LED light is shown in FIG. 1A. The prior art illumination system 50 comprises an LED 10 and a light pipe 11 attached or glued to the top surface of the LED 10. In some cases, the light pipe 11 may have a recessed input cavity enclosing one or more LEDs. Such method is discussed in U.S. Pat. No. 6,560,038 to Parkyn, Jr. et al. and U.S. Pat. No. 7,009,213 B2 to Camras et al. As shown in FIG. 1B, a second known method applies an index matching material 12 between the LED 10 surface and light pipe 11 (or lens) in order to extract more light from the LED 10. This method is discussed in Patent No. WO06000986A2 to Bertram et al.

FIG. 1C shows another known illumination system 70 that utilizes a hemispherical lens 13a and a collimator lens 13b in order to collimate and uniformize the LED 10 light. This method is discussed in U.S. Published Patent Application 2005/0179041 A1 to Harbers et al., U.S. Pat. No. 6,574,423 to Marshall et al., U.S. Pat. No. 6,814,470 to Rizkin et al., U.S. Pat. No. 5,757,557 to Medvedev et al., U.S. Pat. No. 5,485,317 to Perissinotto et al., U.S. Pat. No. 6,940,660 to Blümel, and U.S. Pat. No. 4,767,172 to Nichols et al.

Other known methods utilize micro-optical elements placed on top of the LED surface to extract more light. An example of this approach is discussed in U.S. Pat. No. 6,657,236 to Thibeault et al. An alternative method forms a Fresnel lens or a holographic diffuser on top of an LED surface and utilizes such structure to extract more light from the LED. Such approach is discussed in U.S. Pat. No. 6,987,613 to Pocius et al., U.S. Pat. Nos. 7,015,514 and 6,897,488 to Baur et al. and U.S. Pat. No. 6,598,998 to West et al. In U.S. Pat. No. 6,177,761 to Pelka et al., a light extractor is utilized to extract more light from the LED.

Known illumination systems, such as systems 50, 60 and 70, suffer from one or more of the following disadvantages: (a) lack of compactness due to the need for using long light pipes to deliver acceptable levels of light uniformity, (b) inefficient coupling of LED light to the micro-display in a projection system (c) and lack of control over the spatial distribution of delivered light in terms of angle and intensity.

Therefore, there is a need for a simple, compact and efficient illumination system that provides control over spatial distribution of LED light in terms of intensity and angle.

### SUMMARY

It is an advantage of the present invention to provide a simple, low cost and efficient illumination and projection system capable of producing a light beam of selected cross-section and spatial distribution of light in terms of intensity and angle.

In accordance with an exemplary embodiment of the invention, an illumination system includes one or more extraction optical elements that allow light generated within an LED to exit the LED structure into air via the top and side surfaces of the extraction optical elements, thus, avoiding high optical losses that usually occur within the LED structure.

The invention is not limited to the above exemplary embodiment. Other advantages and embodiments of the invention will be or will become apparent to one with skill in the art upon examination of the following figures and detailed description. It is intended that all such additional advantages and embodiments be included within this description, be within the scope of the invention, and be protected by the accompanying claims.

### BRIEF DESCRIPTION OF THE DRAWINGS

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIGS. 1A-1C show cross-sectional views of prior art illumination systems.

FIG. 2A shows a cross-sectional view of a first illumination system that utilizes an extraction optical element, hollow light pipe, lens, and LED.

FIG. 2B shows a cross-sectional view of a second illumination system that utilizes an extraction optical element, solid light pipe with a cavity, lens, and LED.

FIG. 2C shows a cross-sectional view of a third illumination system that utilizes an extraction optical element, hollow and solid light pipes, lens, and LED.

FIGS. 2D-2E show cross-sectional views of two illumination systems that utilize an extraction optical element, hollow light pipe enclosing the LED, lens, and LED.

FIG. 2F shows a cross-sectional view of an illumination system that utilizes an extraction optical element, hollow light pipe enclosing the LED, lens, and LED with a converting wavelength layer.

FIGS. 3A-3E show cross-sectional views of various shapes and configurations of extraction optical elements.

FIGS. 4A-4B show cross-sectional views of illumination systems that utilize an extraction optical element, hollow and solid light pipes, lens, LED and index matching layer.

FIGS. 4C-4D show cross-sectional views of illumination systems that utilize an extraction optical element, one or more lenses, LED and index matching layer.

FIGS. 5A-5D show cross-sectional views of illumination systems that utilize extraction optical element, hollow and solid light pipes, lens, LED, index matching layer and micro-element plate.

FIG. 5E shows a cross-sectional view of an illumination system that utilizes extraction an optical element, solid light pipe with a cavity, lens, two LEDs enclosed in a three-dimensional reflective cavity, index matching layer and micro-element plate.

FIG. 5F shows a cross-sectional view of illumination system that utilizes an array of extraction optical elements, hollow light pipe, array of LEDs, index matching layer and micro-element plate.

FIGS. 6-9 show various configurations of a micro-element plate.

FIGS. 10-11 show cross-sectional views of various projection systems using transmissive micro-displays.

FIGS. 12A-12C show cross-sectional views of various projection systems using MEMs based reflective micro-displays.

FIGS. 13A-13B show cross-sectional views of two projection systems using liquid crystal based reflective micro-displays.

FIGS. 14A-14B show cross-sectional views of extraction optical elements having photonic crystals.

FIG. 14C shows a cross-sectional view of an extraction optical element having cavities at its bottom surface.

FIG. 14D shows a cross-sectional view of an extraction optical element having cavities at its bottom surface attached to a LED.

It is to be understood that the drawings are solely for purposes of illustration and not as a definition of the limits of the invention. Furthermore, it is to be understood that the drawings are not necessarily drawn to scale and that, unless otherwise stated, they are merely intended to conceptually illustrate the structures and methods described herein.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

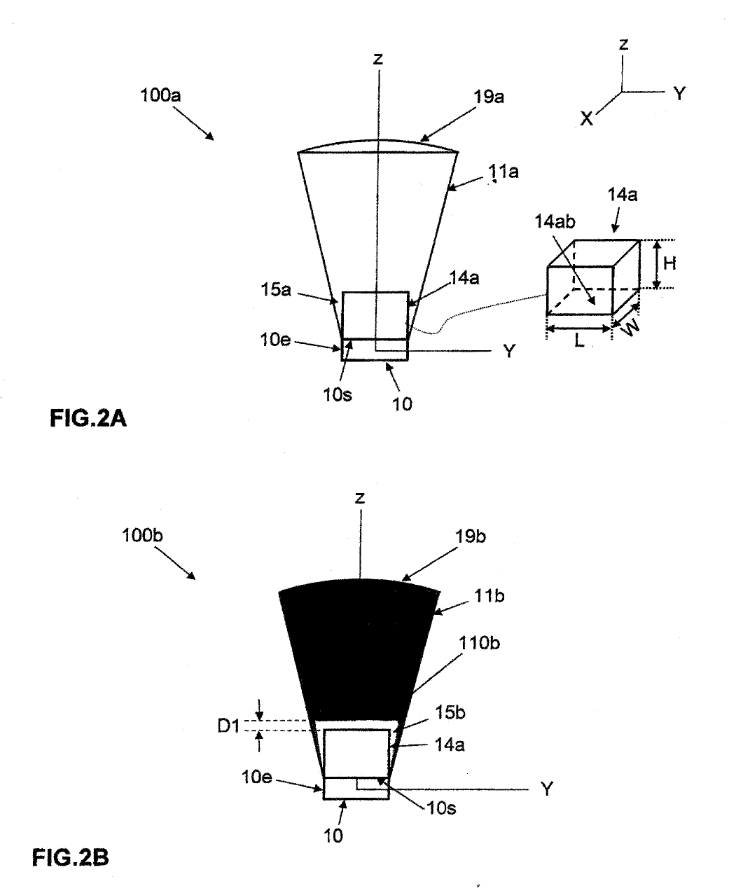

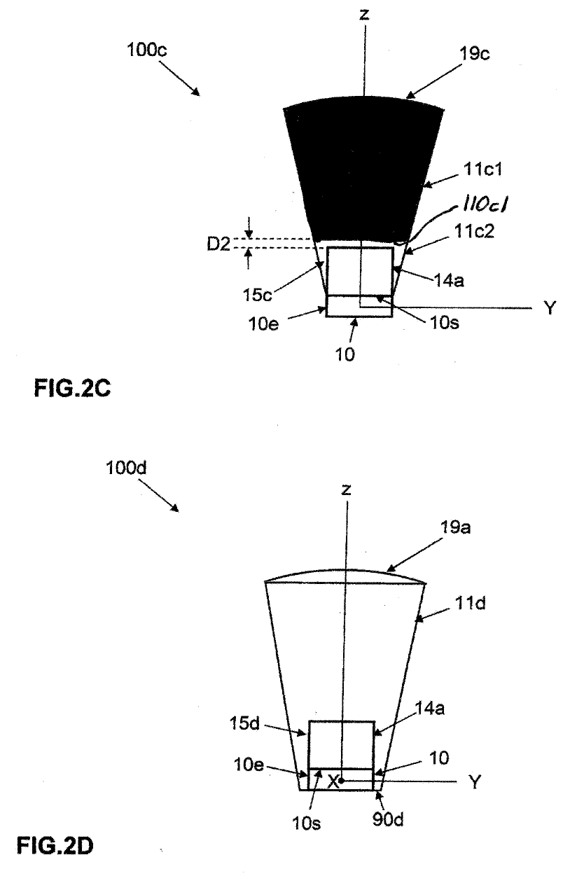

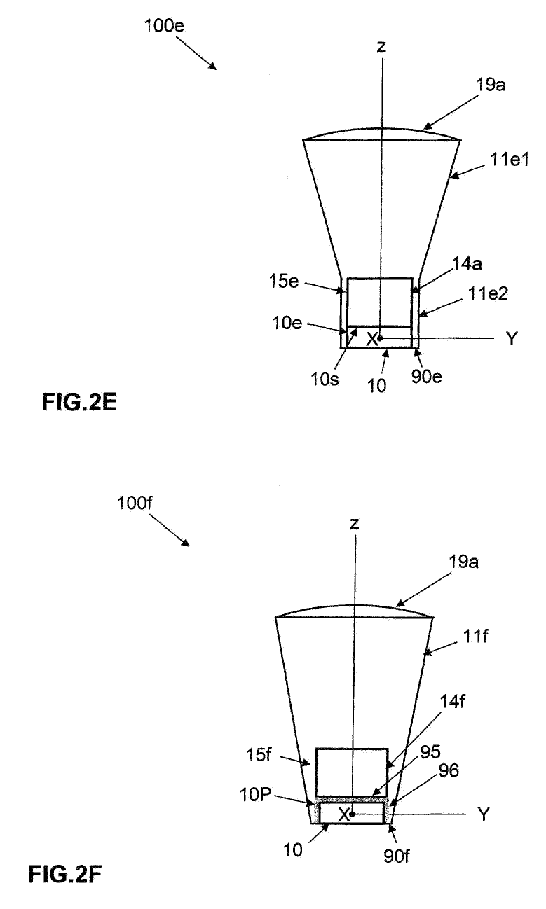

FIG. 2A shows a cross-sectional view of illumination system 100a comprising a light emitting diode (LED) 10, an extraction optical element 14a, an optional tapered hollow light pipe (i.e., light tunnel) 11a and an optional collimating lens 19a.

The extraction optical element 14a is made from an optically transmissive material (i.e., no or low absorption of light) with a refractive index ranging between 1.4 and 3.5 and preferably matching refractive index of the LED material. The extraction optical element 14a is either bonded directly to the LED 10 top surface 10s or glued to surface 10s via an optically transparent adhesive layer with a refractive index ranging between 1.4 and 3.5 and preferably matching the refractive index of extraction optical element 14a. Alternatively, the gap between extraction optical element 14a and top surface 10s of LED 10 can be made small enough (i.e., no greater than one quarter of the LED vacuum wavelength divided by the refractive index of the LED 10 material) in order to allow light generated within LED 10 to enter the extraction optical element 14a without experiencing total internal reflection due to the refractive index of the gap material (e.g., air, epoxy, or optical adhesive).

The cross section (in the XY-plane) 14ab of the extraction optical element 14a can be larger or smaller than cross section of LED 10 and is preferably equal to the cross section of LED 10. The height H of the extraction optical element 14a is preferably equal to the geometric mean of its width W and length L (or equal to its diameter if extraction optical element 14a has a circular cross section). In addition, the extraction optical element 14a is totally enclosed within the entrance aperture of the optional tapered light tunnel 11a while an open cavity 15a surrounding the four sidewalls of the extraction optical element 14a is maintained in order to allow some of the light to exit to air through the sidewalls of extraction element 14a. The open cavity 15a preferably contains air but can be filled with another material (solid, fluid or gaseous) having a low refractive index with a value of less than (n−0.2), where n is the refractive index of extraction optical element 14a. The entrance and exit apertures of tapered light tunnel 11a can be, for example, circular, square or rectangular and tapered light tunnel 11a can have straight sidewalls or curved ones such as these of compound parabolic or elliptical collectors. The sidewall(s) of the tapered light tunnel 11a usually has reflective coatings on the inside surface with reflectivity exceeding 50%, preferably exceeding 90%, and more preferably exceeding 99%. The optional lens 19a is made from glass or other material with an index of refraction of about 1.4-2.

As shown in FIG. 2B, a second illumination system 100b comprises a light emitting diode (LED) 10, the extraction optical element 14a, optional tapered solid light pipe (rather than a hollow pipe) 11b with a cavity 15b and an optional collimating lens 19b.

The light pipe 11b is made from an optically transmissive material with a refractive index ranging between 1.4 and 3.5 and preferably between 1.4 and 1.6. The cavity 15b material can be air or other material with an index of refraction of less than of equal to (n−0.2), where n is the refractive index of the extraction optical element 14a. Cavity 15b is preferably present around the whole sidewall areas of the extraction optical element 14a rather than part of it. The distance D1 between the top surface of the extraction optical element 14a and the bottom flat side 110b of pipe 11b ranges between zero and several millimeters. The size of the cavity around the sidewalls of extraction optical element 14a is preferably larger than zero at all the sidewall points.

The optional collimating lens 19b can be made as an integral part of the light pipe 11b via a molding process or can be made separately then attached or bonded to the light pipe 11b.

As shown in FIG. 2C, a third illumination system 100c utilizes an optional tapered solid light pipe 11c1 combined with an optional tapered light tunnel 11c2 rather than using a single solid pipe or tunnel. The tapered light tunnel 11c2 encloses extraction optical element 14a and provides a cavity 15c around it. Lensed and tapered solid light pipe 11c1 is attached to tapered light tunnel 11c2. The distance D2 between the top surface of extraction optical element 14a and the bottom flat side 110c1 of pipe 11c1 can be zero or more.

As shown in FIG. 2D, a fourth illumination system 100d utilizes an optional tapered light tunnel 11d that encloses LED 10 as well as extraction optical element 14a. The entrance aperture of tapered light tunnel 11d can be equal or larger than the LED cross section (in the XY plane). A larger entrance aperture allows the collection of light that emerges from the edges of LED 10. A highly reflective film or coating 90d is provided at the entrance aperture of tapered light tunnel 11d and around the bottom side of LED 10. This film/coating 90d can be flat or curved and sometimes comes as an integral part of the LED 10 structure (e.g., Lumileds LEDs).

As shown in FIG. 2E, a fifth illumination system 100e includes an optional tapered light tunnel 11e1 let combined with an optional straight tunnel 11e2 that encloses the LED 10 as well as the extraction optical element 14a. A cavity 15e around the extraction optical element 14a and the LED 10 is also present. A highly reflective film or coating 90e is provided at the entrance aperture of tapered light tunnel 11d and around the bottom side of LED 10.

As shown in FIG. 2F, a sixth illumination system 100f shows an optional tapered light tunnel 11f that encloses the LED 10 as well as an extraction optical element 14f where LED 10 has one or more layers 10P covering its top surface and possibly its edges. The layer 10P can be, for example, a wavelength converting material (e.g., a fluorescent material such as phosphor) that converts the wavelength of light produced within the LED 10 structure. Other examples of layer 10P include polarizers (e.g., wire-grid polarizer), diffractive optical element, refractive optical element, holographic structures, interference filters and dichroic filters. When the layer 10P is present on top surface and edges of LED 10, the top surface 95 and outside sidewall surfaces 96 of layer 10P are treated as the top surface and sidewall surfaces of LED 10. A cavity 15f around extraction optical element 14f and LED 10 is also present in this case. Again, an optional highly reflective film or coating 90f is provided at the entrance aperture of tapered light tunnel 11d and around the bottom side of LED 10.

Other variations of arrangements shown in FIGS. 2A-2F are possible and are considered part of this disclosure. For example, illumination systems 100d, 100e and 100f of FIGS. 2D-2F can be constructed with solid and hollow pipes 11b, 11c1 and 11c2 (lensed or non-lensed) of FIGS. 2B-2C.

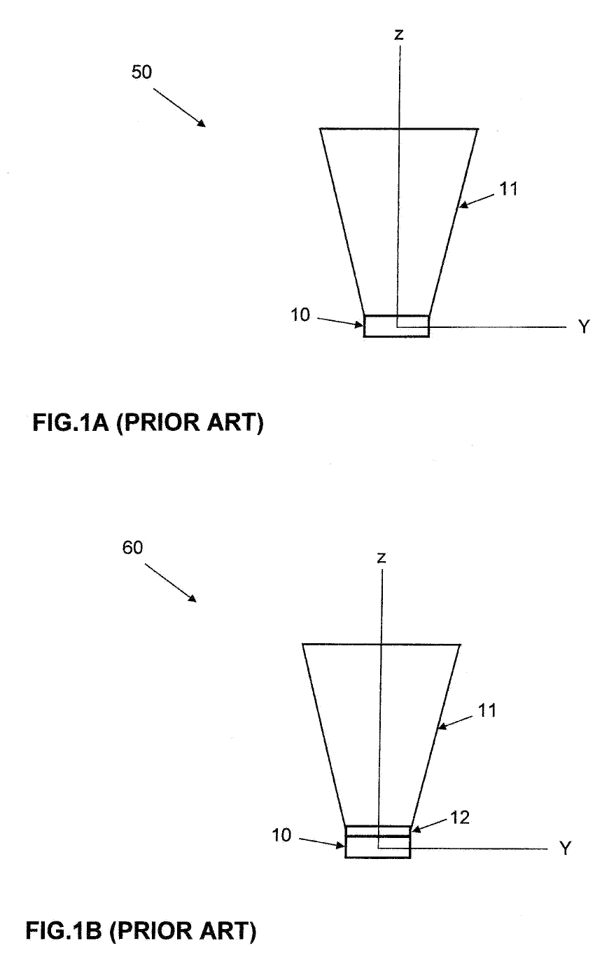

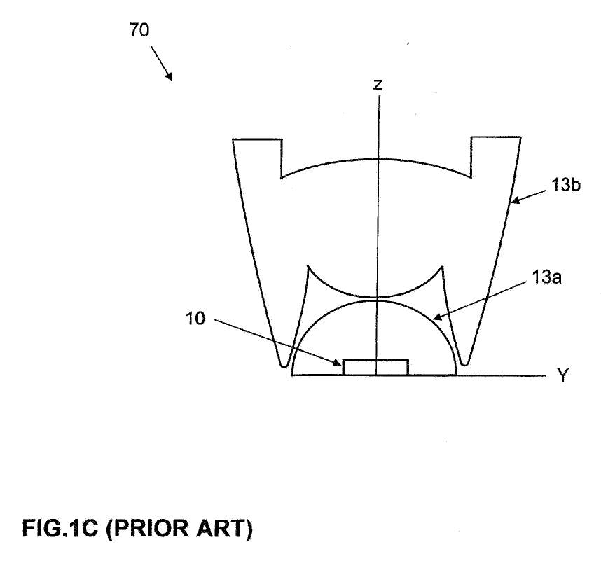

The operation of illumination system 100a, 100b, 100c, 100d, 100e and 100f is explained as follows. Most of light generated within the LED 10 exits through its top surface 10s and 95 into extraction optical element 14a and 14f assuming the refractive indices of the extraction optical elements 14a and 14f and LED 10 are equal or assuming that index matching layer 17 is efficient in coupling most of LED 10 light into extraction optical element 14a and 14f. If the refractive index of the extraction optical elements 14a and 14f is lower than that of LED 10, some of the LED 10 light will be trapped within the LED 10 and will not enter extraction optical element 14a and 14f. This trapped light propagates within the LED 10 structure experiencing significant optical losses until some of it exits through the LED 10 edges. The use of the extraction optical elements 14a and 14f allows some or all of trapped light (depending on the refractive indices of the extraction optical elements 14a and 14f, LED 10 layers and index matching layer 17) to be coupled out of the LED 10 structure, where the optical losses usually occur, into the transparent extraction optical elements 14a and 14f, where very low optical losses occur. Most light received by the extraction optical elements 14a and 14f exits through the sidewalls and top surface of the extraction optical elements 14a and 14f and the remainder is reflected back via total internal reflection (TIR) toward the LED 10 structure, which in turn reflects some of that light back toward the extraction optical elements 14a and 14f. Some of this light gets reflected off the top surface of the LED 10 (e.g., by the metal contacts and Fresnel reflections) and some of it gets reflected back by the internal structure of the LED 10 (e.g., by a mirror at the back of the LED 10, Fresnel reflections and photon recycling). Therefore, the extraction optical elements 14a and 14f provide an advantage by allowing trapped LED light to propagate in an approximately lossless medium until it exits through its sidewalls and top surface rather than exiting through the LED 10 edges. If the extraction optical elements 14a and 14f have a diffusive layer in their structures (e.g. textured top surface), light that does not exit through the sidewalls and top surface of extraction optical elements 14a and 14f upon encountering them for the first time is diffused or scattered, allowing some of this scattered light to exit when it encounters sidewalls and top surface of the extraction optical element 14a and 14f for a second time, and thus, leading to a better extraction efficiency of trapped LED 10 light, especially if the LED structure does not have a diffusive layer (e.g., textured surface). In addition, greatly reducing the LED light that exits through the LED 10 edges eliminates the need for a light pipe/tunnel (e.g., tunnel 11d of FIG. 2D) with an entrance aperture larger in size than the LED 10 cross section. This allows the use of a light pipe with an entrance aperture slightly larger than or equal to the LED 10 cross section. This leads to a more efficient coupling of LED light into a micro-display panel with a limited etendue in a projection system. U.S. Pat. No. 6,649,440 to Krames et al. shows that an increased LED thickness results in an increased light output by allowing light to exit through the LED edges without experiencing many reflections within the LED structure. This patent is incorporated herein by reference. Measurements shows that our illumination system 100a of FIG. 2A (without using a lens 19a) has 20-60% increase (depending on LED type and wavelength) of light output at all cone angles when compared to conventional illumination system 50 of FIG. 1A (using a light tunnel).

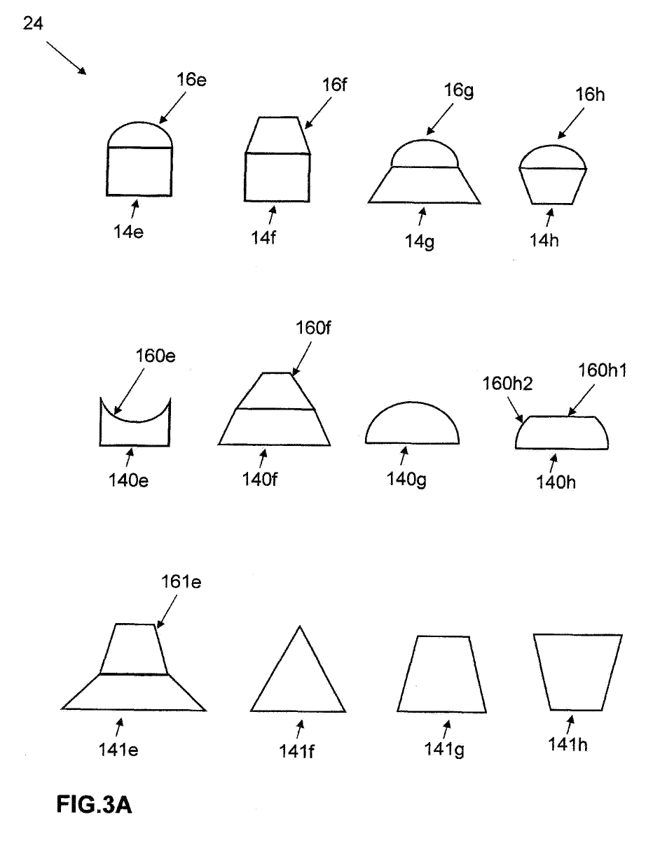

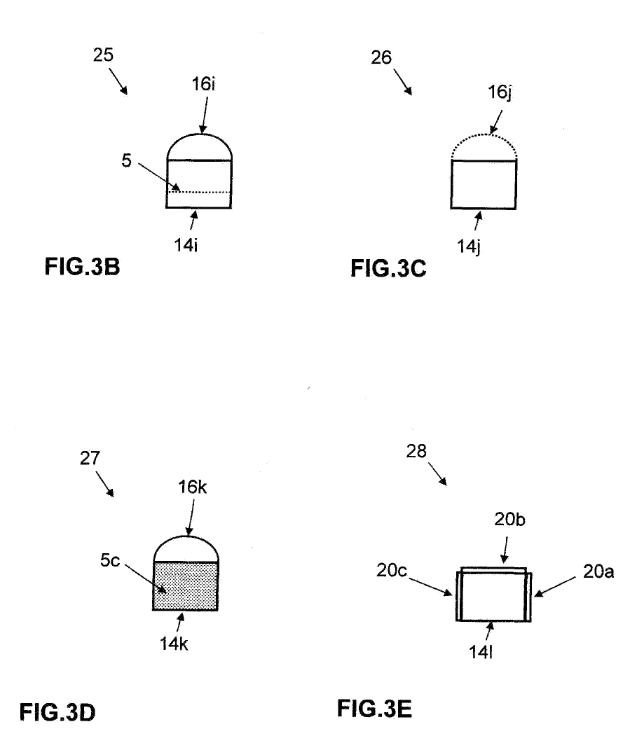

FIGS. 3A-3E show various shapes and structures 24, 25, 26, 27 and 28 of different extraction optical elements. The various extraction optical elements can be included in the illumination and projection systems disclosed herein.

FIG. 3A shows cross-sectional views of a lensed extraction optical element 14e, an extraction optical element 14f with a truncated (can be non-truncated) pyramidal body 16f having three or more surfaces, a lensed and positively-tilted extraction optical element 14g, a lensed, negatively-tilted extraction optical element 14h, an extraction optical element 140e with a concave lens 160e, a positively-tilted extraction optical element 140f with a truncated (can be non-truncated) pyramidal body 160f having three or more surfaces, an extraction optical element 140g having a lens shape, an extraction optical element 140h having a flat top 160h1 and curved sidewalls 160h2, a positively-tilted extraction optical element 141e with a truncated (can be non-truncated) pyramidal body 161e having three or more surfaces, an extraction optical element 141f having a positively-tilted pyramidal body with three or more surfaces, an extraction optical element 141g having a truncated and positively-tilted pyramidal body with three or more surfaces, and an extraction optical element 141h having a truncated and negatively-tilted pyramidal body with three or more surfaces.

FIG. 3B shows a lensed extraction optical element 25 with an internally diffusive layer 5 and FIG. 3C shows a lensed extraction optical element 26 with a diffusive structure made in the surface of lens 16j.

FIG. 3D shows an extraction optical element 27 having a body 14k with diffusive surfaces 5c (including sidewalls, top and bottom surfaces) and an optional lens 16k on top of its body 14k.

FIG. 3E shows a cross-sectional view of an extraction optical element 28 having a square body 14l with micro-element plates 20a, 20b and 20c (only cross sections of three plates are shown) attached to one or more of its surfaces. Micro-element plates 20a, 20b and 20c can have nano and/or micro structures (e.g., micro-lenses, micro-guides, nano-particles and nano-structures). Other examples such structures include polarizers, diffractive optical element, refractive optical element, holographic structures, interference filters, and dichroic filters. It is possible to have such nano and/or micro structures made as an integral part of the extraction optical element 28 rather than attaching one or micro-element plates 20a, 20b and 20c to one or more of its surfaces.

The extraction optical elements 14e, 14f, 14g, 14h, 140e, 140f, 140g, 140h, 141e, 141f, 141g, 141h, 14i, 14j, 14k and 14l can each have various shapes, such as square, rectangular, cylindrical and irregular. The lenses 16e, 16g, 16h, 160e, 16i, 16j and 16k can each be convex, concave, spherical, aspherical, Fresnel or a micro-lens array. Other variations of extraction optical elements 24, 25, 26, 27 and 28 are possible and may include, for example, a diffusive structure or a coating on one or more of their surfaces (e.g. top, bottom and sidewalls). Such a coating or structure can be applied to or made as an integral part of extraction optical elements 24, 25, 26, 27 and 28.

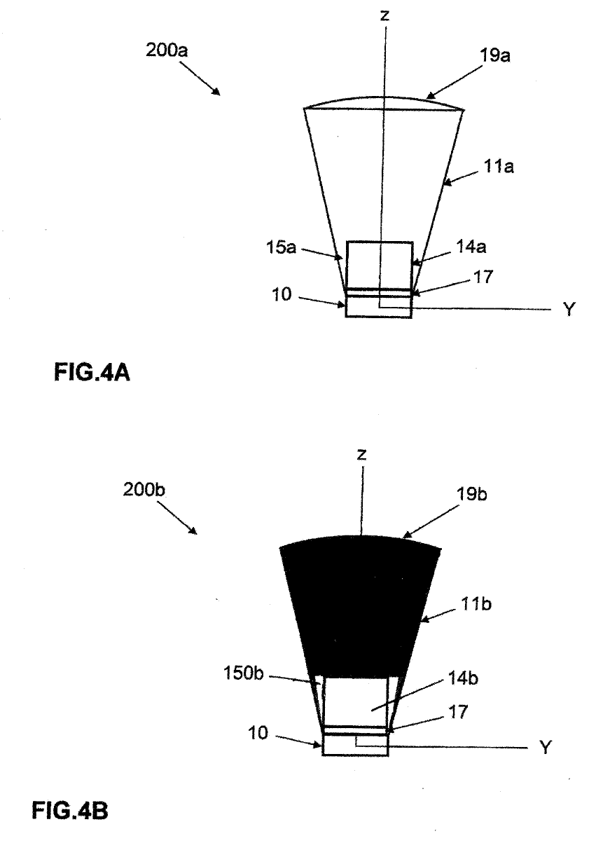

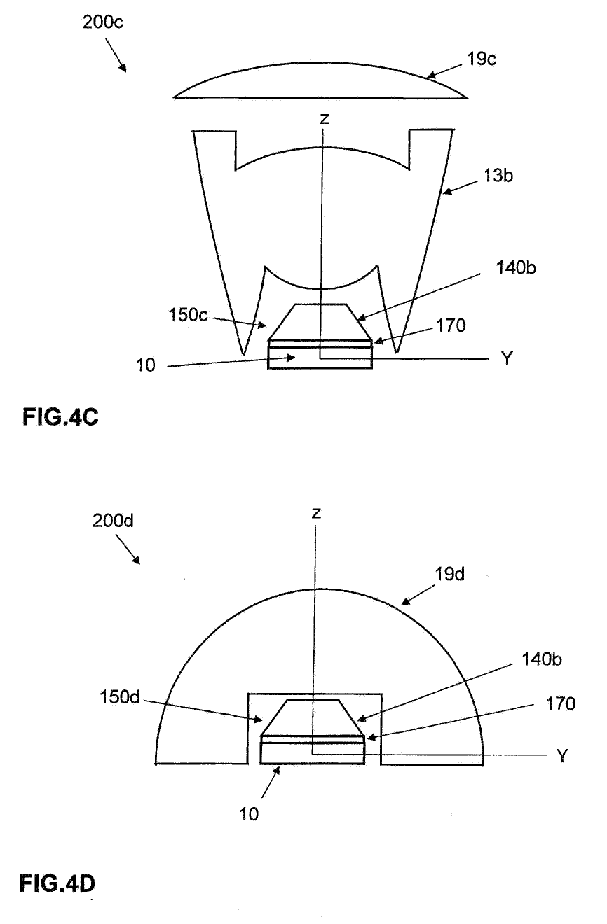

FIGS. 4A-4D show cross-sectional views of illumination systems 200a, 200b 200c and 200d that utilize an index matching layer 17 and 170 between top layer of LED 10 and extraction optical element 14a, 14b and 140b. Index matching layer 17 and 170 can have variable refractive index with a value equal to the refractive index of LED 10 at the top surface of LED 10 and decreases continuously (or in steps) until it reaches a value equal to the refractive index of extraction optical element 14a, 14b and 140b at the bottom side of extraction optical element 14a, 14b and 140b. It is also possible for the index matching layer 17 and 170 to have a fixed refractive index with its value being smaller than or equal to the refractive index of LED 10 and larger than or equal to the refractive index of extraction optical element 14a, 14b and 140b.

FIG. 4A shows a cross-sectional view of an illumination system 200a comprising the LED 10, extraction optical element 14a, tapered light tunnel 11a, index matching layer and an optional collimating lens 19a.

FIG. 4B shows a cross-sectional view of an illumination system 200b that includes a tapered light pipe 11b with a cavity 150b enclosing extraction optical element 14b, LED 10, extraction optical element 14b, index matching layer 17 and an optional collimating lens 19b.

Illumination systems 100a, 100b, 100c, 100d, 100e and 100f of FIGS. 2A-2F may also be constructed with an index matching layer 17.

FIG. 4C shows a cross-sectional view of illumination systems 200c comprising LED 10, extraction optical element 140b, optional collimating lens 13b, index matching layer 170 and an optional lens 19c.

FIG. 4D shows a cross-sectional view of illumination systems 200d comprising LED 10, extraction optical element 140b, index matching layer 170 and an optional lens 19d. It is also possible to bond extraction optical element 140b directly to the top surface of LED 10 without using index matching layer 170. Extraction optical elements of other shapes such as these of FIG. 3 may be used instead of extraction optical element 14a, 14b and 140b of FIGS. 4A-4D. Other variations of lens 13b and 19c can be used, such as the ones described in U.S. Published Patent Application 2005/0179041 A1 to Harbers et al., U.S. Pat. No. 6,574,423 to Marshall et al., U.S. Pat. No. 6,814,470 to Rizkin et al., U.S. Pat. No. 5,757,557 to Medvedev et al., U.S. Pat. No. 5,485,317 to Perissinotto et al., U.S. Pat. No. 6,940,660 to Blümel, and U.S. Pat. No. 4,767,172 to Nichols et al., which are all incorporated herein by reference.

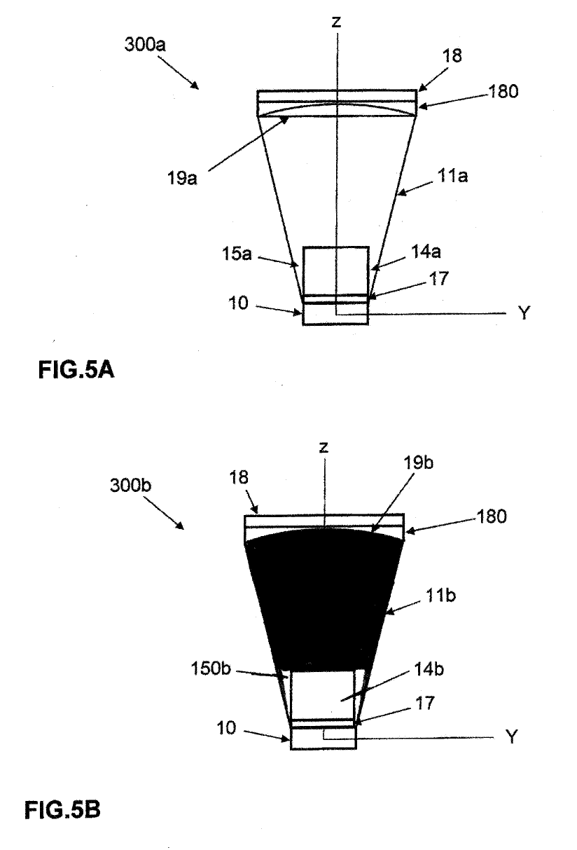

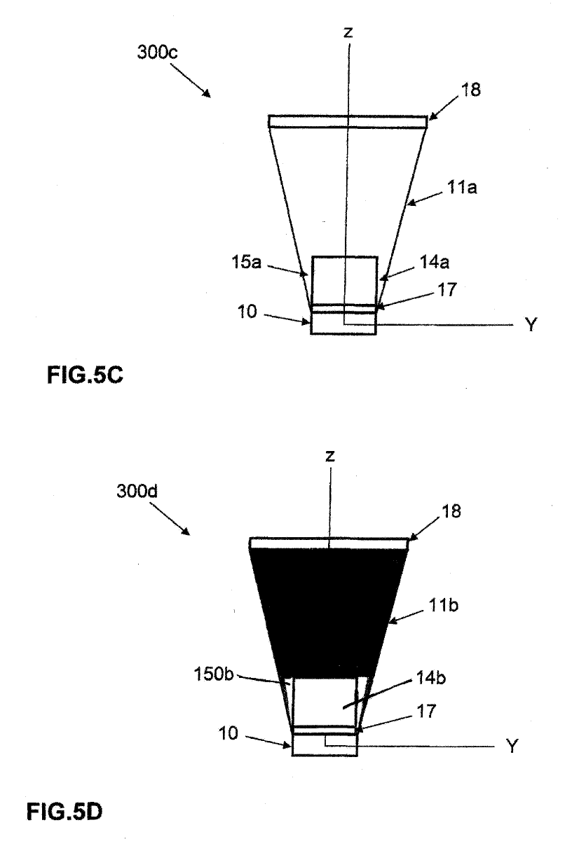

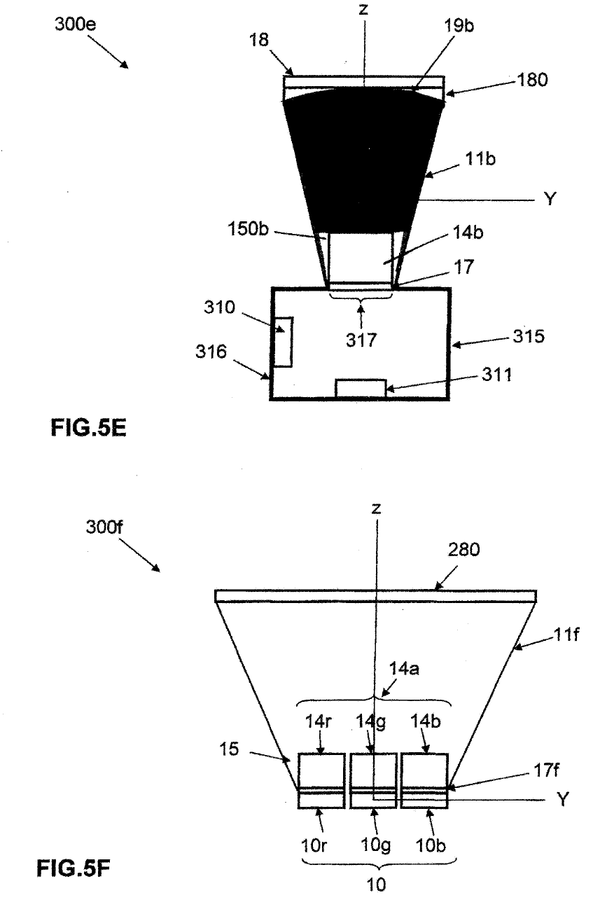

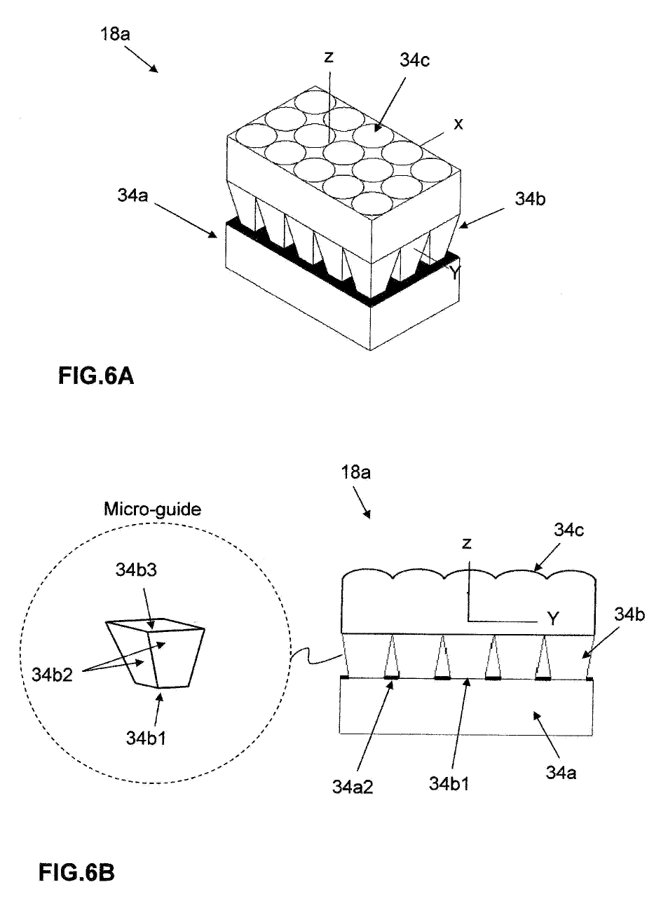

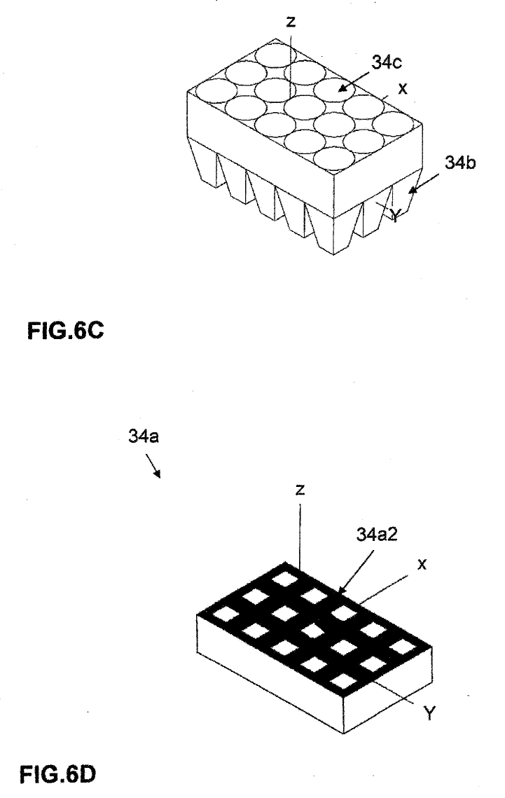

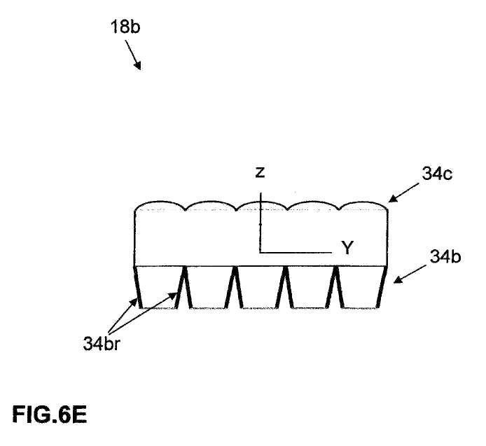

FIGS. 5A-5B show cross-sectional views of illumination systems 300a and 300b that utilize a micro-element plate 18 at the exit aperture of tapered light tunnel and pipe 11a and 11b in addition to LED 10, extraction optical element 14a and 14b, index matching layer 17 and an optional collimating lens 19b. Structures of micro-element plate 18 are shown in FIGS. 6-9. An optional highly reflective coating or film 180 can be used to prevent light leakage around the edges of the exit apertures of light tunnel/pipe 11a and 11b.

Illumination systems 300c and 300d of FIGS. 5C-5D are the same as illumination systems 300a and 300b of FIGS. 5A-5B except for the removal of lenses 19a and 19b.

FIG. 5E shows an illumination system 300e utilizing a three dimensional reflective cavity 315 enclosing one or more LEDs 310 along one or more of its sidewalls as well as optional LEDs 311 at its bottom side, extraction optical element 14b, optional tapered light pipe 11b, optional index matching layer 17, an optional collimating lens 19b, and an optional micro-element plate 18. Light cavity 315 is made of a material of refractive index n, ranging between 1.4 and 3.5. In this case, extraction optical element 14b is bonded directly or via an index matching layer 17 to the exit aperture 317 of cavity 315. Extraction optical elements of other shapes, such as those of FIG. 3, may be used instead of extraction optical element 14b.

Cavity 315 has reflective surfaces 316 and an exit aperture 317 having an area smaller than the area of the enclosed LEDs 310 and 311. In an alternative arrangement, at least one of the enclosed LEDs (along the cavity's sidewalls and at its bottom side) is attached to an extraction optical element having a refractive index nₑ via an optional index matching layer where the refractive index n_{c} of the three dimensional reflective cavity 315 is smaller than (nₑ−0.2). In another arrangement, extraction optical element 14b at the exit aperture 317 of three dimensional reflective cavity 315 (i.e., FIG. 5E) is removed, and at least one of the enclosed LEDs is attached to an extraction optical element. U.S. Pat. No. 6,869,206 B2 to Zimmerman et al. discusses various arrangements of this type of cavity and is incorporated herein by reference. Other arrangements of illumination systems of this disclosure can also be used with a three dimensional optical cavity 315, rather than being applied directly to the top surface of the LED 10, as shown in FIGS. 2, 4 and 5A-5D.

FIG. 5F shows a cross-sectional view of an illumination system 300f comprising an array 10 of LEDs 10r, 10g and 10b, an array 14a of extraction optical elements 14r, 14g and 14b, optional tapered light tunnel 11f, optional index matching layer 17f and optional micro-element plate 280. A lens at the exit of light tunnel 11f (below micro-element plate 280) may also be used. The LED array 10 can have LEDs with one color or LEDs with different colors such as red 10r, green 10g and blue 10b. It is also possible to have a single extraction optical element bonded to the LED array 10, rather than an array 14a of extraction optical elements.

All of the illumination systems disclosed herein can also be used with array of LEDs rather than single LED.

In one arrangement, plate 18 and 280 can be one or a combination of two or more of the followings: a) an optical coating that transmits part of incident light regardless of its angle and reflects the remainder of incident light, b) an interference filter that transmits part of incident light within a selected cone angle and reflects the remainder of incident light, c) a polarizer such as a wire-grid polarizer, or d) a micro-element plate as shown in FIGS. 6-9.

FIGS. 6-9 show other arrangements 18a, 18b, 18c, 18d, and 18e of plate 18 and 280.

FIG. 6A shows a perspective view of the plate 18a, which consists of an aperture plate 34a, micro-guide array 34b and a micro-lens array 34c. Each micro-lens corresponds to a micro-guide and a micro-aperture. As shown in FIG. 6B, the aperture array 34a consists of a plate made of a highly transmissive material 34a with a patterned highly reflective coating 34a2 applied to its top surface. The index of refraction of array 34a can have any chosen value and is preferably about 1.4-1.6. A perspective view of the micro-guide 34b and micro-lens 34c arrays is shown in FIG. 6C. Both arrays 34b and 34c can be made on a single plate.

A perspective view of the aperture 34a is shown in FIG. 6D.

Design parameters of each micro-element (e.g., micro-guide, micro-lens or micro-tunnel) within an array 34a, 34b and 34c include shape and size of entrance and exit apertures, depth, sidewalls shape and taper, and orientation. Micro-elements within an array 34a, 34b and 34c can have uniform, non-uniform, random or non-random distributions and range from one micro-element to millions with each micro-element being distinct in its design parameters. The size of the entrance/exit aperture of each micro-element is preferably greater than or equal to 5 μm in case of visible light in order to avoid light diffraction phenomenon. However, it is possible to design micro-elements with sizes of entrance/exit aperture being less than 5 μm. In such case, the design should consider the diffraction phenomenon and behavior of light at such scales to provide homogeneous distribution of collimated light in terms of intensity, viewing angle and color over a certain area. Such micro-elements can be arranged as a one-dimensional array, two-dimensional array, circular array and can be aligned or oriented individually. In addition, plate 18 and 280 can have a size equal or smaller than the size of the exit aperture of light pipe/tunnel 11a, 11b and 11f and its shape can be rectangular, square, circular or any other arbitrary shape.

In an alternative arrangement, and as shown in FIG. 6E, extraction plate 18b does not have an aperture array and the sidewalls of the micro-guides within micro-guide array 34b are coated with a highly reflective coating 34br.

The operation of the plates 18a and 18b is described as follows. Part of the light impinging on the plates 18a and 18b enters through the openings 34b1 of the aperture array 34a and the remainder is reflected back by the highly reflective coating 34a2 and 34br toward the LED 10. Some of this light gets absorbed and lost within the LED 10, some gets absorbed and regenerated with a different angle, and the remainder gets reflected back toward plate 18a and 18b by a reflective coating formed on the bottom side of the LED 10 and/or TIR depending on the LED 10 structure. This process continues until all the light is either absorbed or transmitted through plate 18a and 18b. Light received by the micro-guide array 34b experiences total internal reflection (or specular reflection in case of plate of FIG. 6E) within the micro-guides and becomes highly collimated as it exits array 34b. This collimated light exits the micro-lens array 34c via refraction as a more collimated light. In addition to collimating light, plate 18a and 18b provides control over the distribution of delivered light in terms of intensity and cone angle at the location of each micro-element.

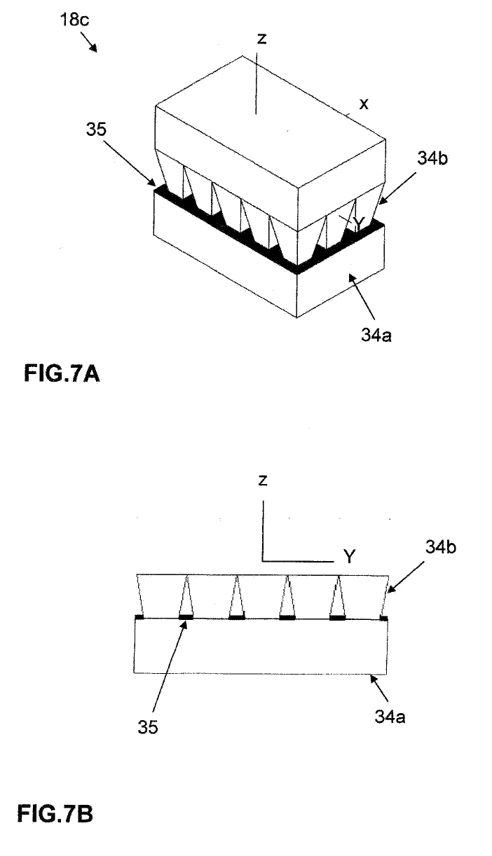

FIGS. 7A and 7B show perspective and cross-sectional views of plate 18c consisting of a micro-guide array 34b and an aperture array 34a.

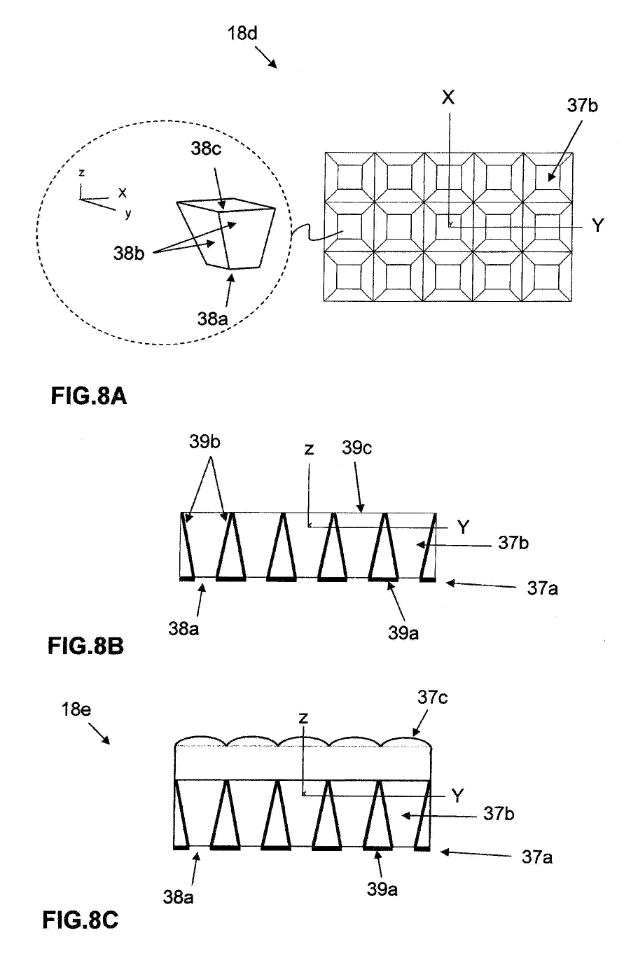

FIGS. 8A and 8B show perspective and cross-sectional views of plate 18d consisting of a micro-tunnel array 37b and an aperture array 37a. The internal sidewalls 38b (exploded view of FIG. 8A) of each micro-tunnel are coated with a highly reflective coating 39b (FIG. 8B). Part of the light impinging on plate 18d enters the hollow micro-tunnel array 37b and gets collimated via reflection. The remainder of this light gets reflected back by the highly reflective coating 39a of aperture array 37a. The advantages of extraction plate 18d are compactness and high transmission efficiency of light without the need for anti-reflective (AR) coatings at the entrance 38a and exit 38c apertures of its micro-tunnels. FIG. 8C shows a cross-sectional view of plate 18e consisting of a micro-tunnel array 37b, an aperture array 37a and a micro-lens array 37c. In another arrangement, micro-tunnels of array 37b are filled with a high refractive index material.

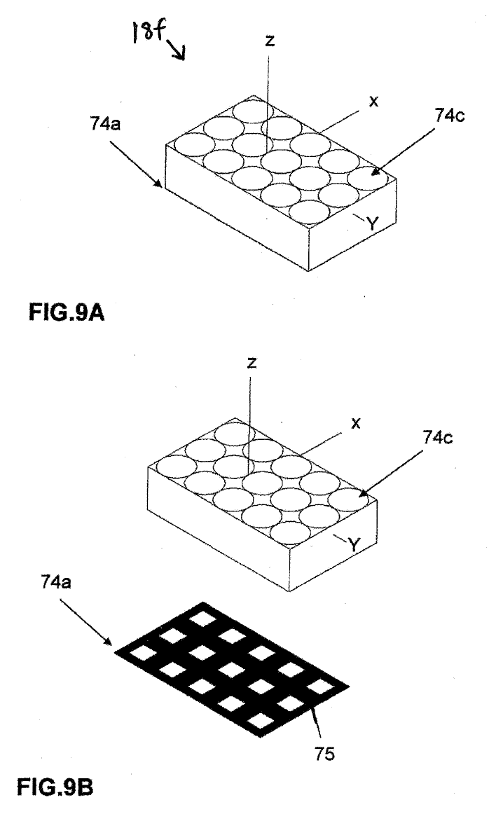

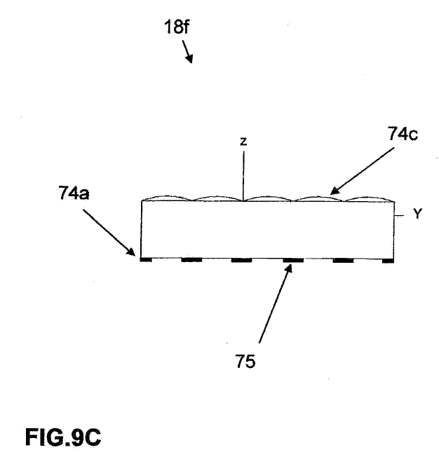

FIGS. 9A, 9B and 9C show perspective (integrated and exploded) and cross-sectional views of plate 18f consisting of an aperture array 74a and a micro-lens array 74c made on a single plate. In this case, the micro-lens array 74c performs the collimation function via refraction.

The reflective coatings 34a2, 35, 39a and 75 of aperture arrays 34a (FIGS. 6A-6D and FIGS. 7A-7B), 37a (FIGS. 8A-8C) and 74a (FIGS. 9A-9C) can be of specular or diffusive type, whereas, sidewall reflective coatings 34br and 39b are preferably of the specular type in order to perform the collimation function.

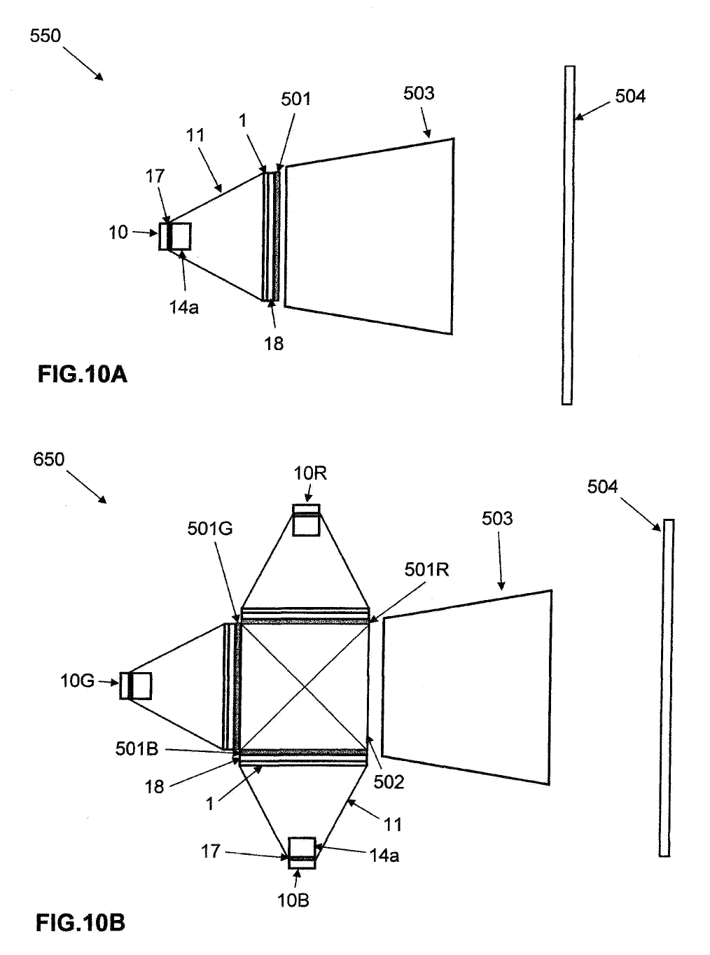

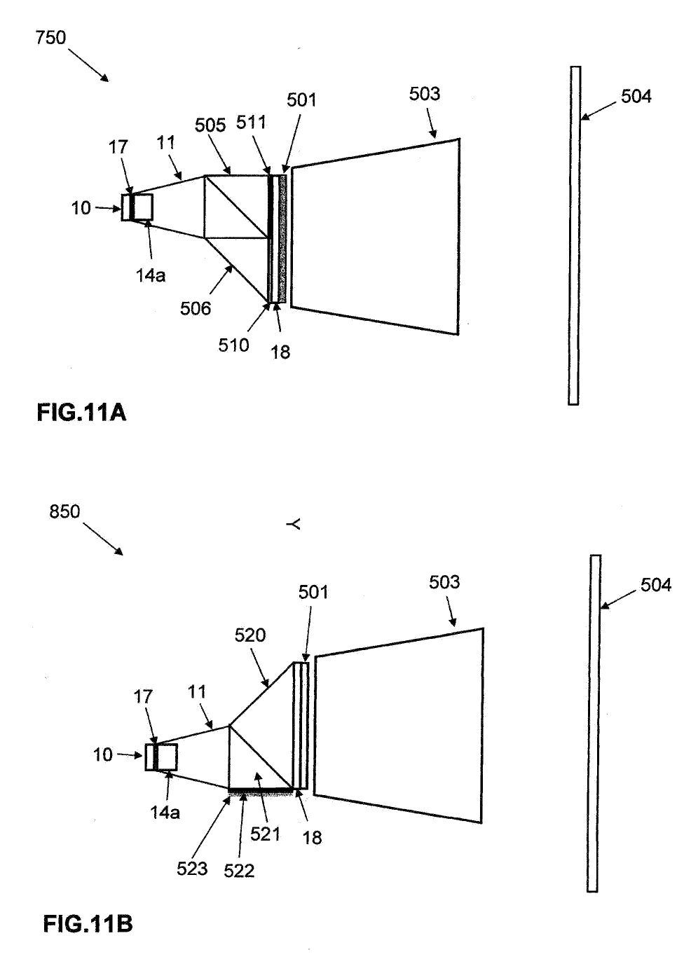

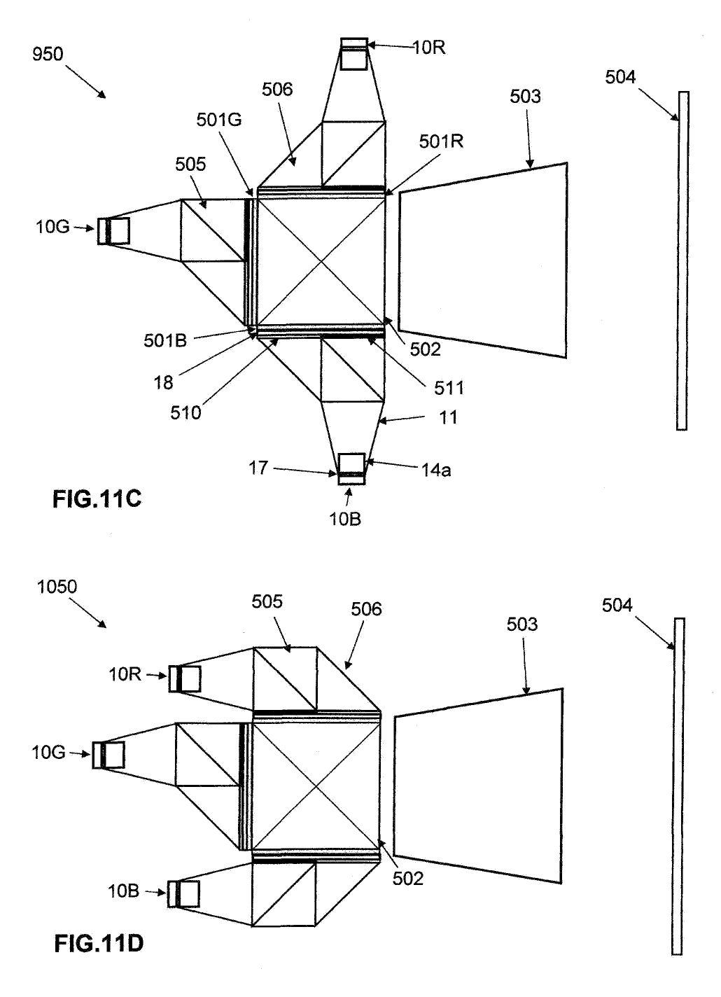

FIGS. 10 and 11 show cross-sectional views of projection systems 550, 650, 750, 850, 950 and 1050 that use transmissive micro-display panels 501, 501R, 501G and 501B such as high temperature poly-silicon (HTPS) display panels made by Seiko-Epson and Sony.

FIG. 10A shows a projection system 550 that utilizes a single transmissive micro-display panel 501, which is a color liquid crystal display such as these made by Sony. The LED 10 is either a white LED or a combination, for example, of red, green and blue LEDs that produce a white color. Polarizer 1 may be a reflective polarizer (e.g., Moxtek polarizer) or any other type of polarizer. Matching index layer 17, extraction optical element 14a, pipe/tunnel 11 and optional plate 18 have been described earlier.

FIG. 10B shows a projection systems 650 that utilizes three transmissive micro-display panels 501R, 501G and 501B, which are illuminated by LEDs with different colors, preferably, red 10R, green 10G and blue 10B. Micro-display panels 501R, 501G and 501B can be, for example, high temperature poly-silicon (HTPS) display panels as the ones made by Seiko-Epson and Sony. The images of the three micro-displays 501R, 501G and 501B are combined with a prism 502 (e.g. X cube) and then projected via a projection lens 503 onto a screen 504. Matching index layer 17, extraction optical element 14a, pipe/tunnel 11, polarizer 1 and optional plate 18 have been described earlier. Polarization conversion in these projection systems 550 and 650 is achieved by passing light with one polarization through polarizer 1 and recycling light with the other polarization through the light tunnel 11, extraction optical element 14a, index matching layer 17 and LED 10, 10R, 10G, and 10B until most of the light exits polarizer 1.

FIG. 11A shows a cross-sectional view of a projection system 750 that utilizes a single transmissive micro-display 501 with a polarization conversion arrangement consisting of a polarization beam splitter (PBS) cube 505, a prism reflector 506, a half wave plate 510, and spacer 511. Light exiting tunnel 11 is coupled into the PBS cube 505 where light with one polarization state (e.g., p state) is transmitted to optional plate 18 through a spacer 511 and light with orthogonal polarization state (e.g. s state) is reflected toward a prism reflector 506. At the surface of the prism reflector 506, light with orthogonal polarization state (e.g., s state) is reflected toward the half wave plate 510 where its polarization state is converted into the orthogonal state (e.g. p state) and enters optional plate 18.

Projection system 850 of FIG. 11B is similar to projection system 750 of FIG. 11A except for the use of a quarter wave plate 522 as well as prisms 520 and 521. The bottom side of quarter wave plate 522 usually has a highly reflective coating or mirror 523 applied to it in order to reflect light that enters quarter wave plate 522 from prism 521 back into prism 521. Since this reflected light passes through quarter wave plate 522 twice, its polarization state gets rotated to an orthogonal polarization state.

FIG. 11C shows a cross-sectional view of a projection system 950 that is the same as projection system 650 of FIG. 10B except for the use of a polarization conversion arrangement similar to that of FIG. 11A.

FIG. 11D shows a cross-sectional view of a projection system 1050 that has folded illumination configurations (i.e., the ones associated with LEDs 10R and 10B). Components of projection system 1050 of FIG. 11D are the same as these of projection system 950 of FIG. 11C.

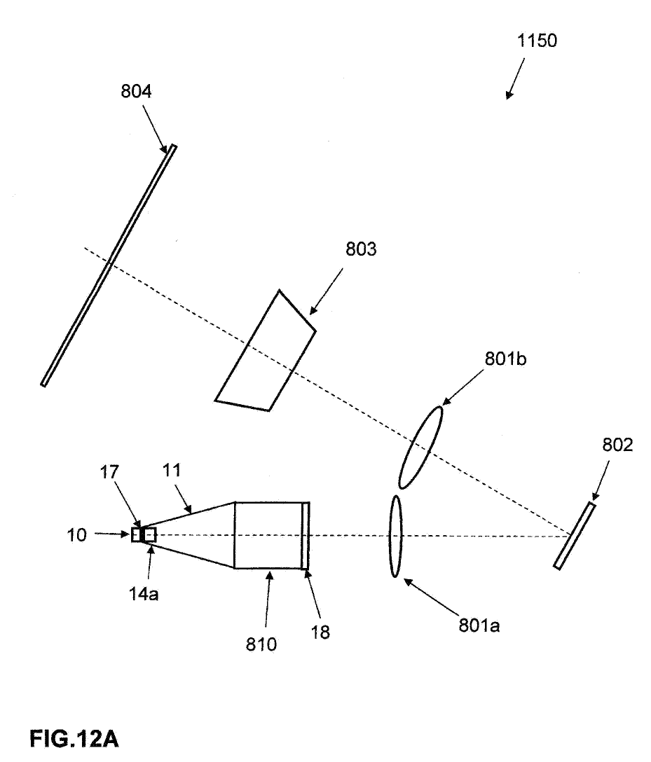

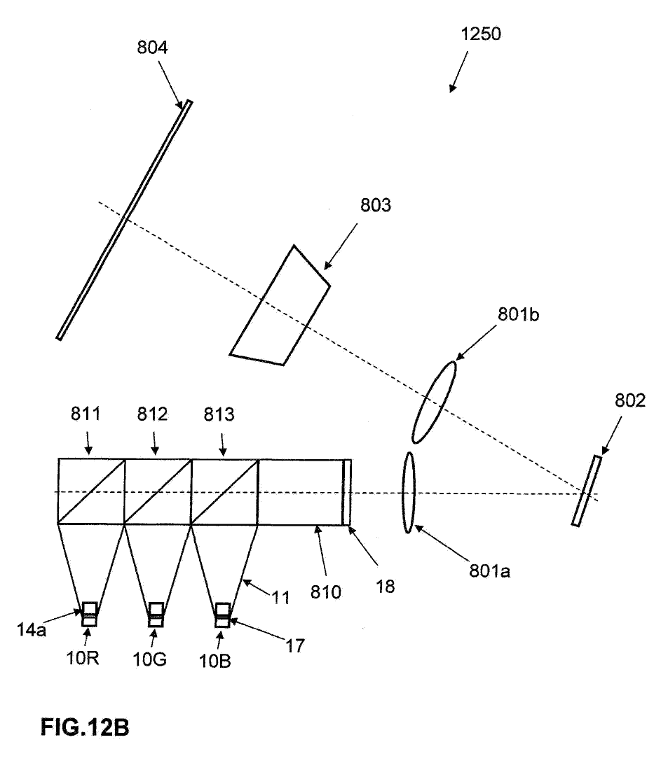

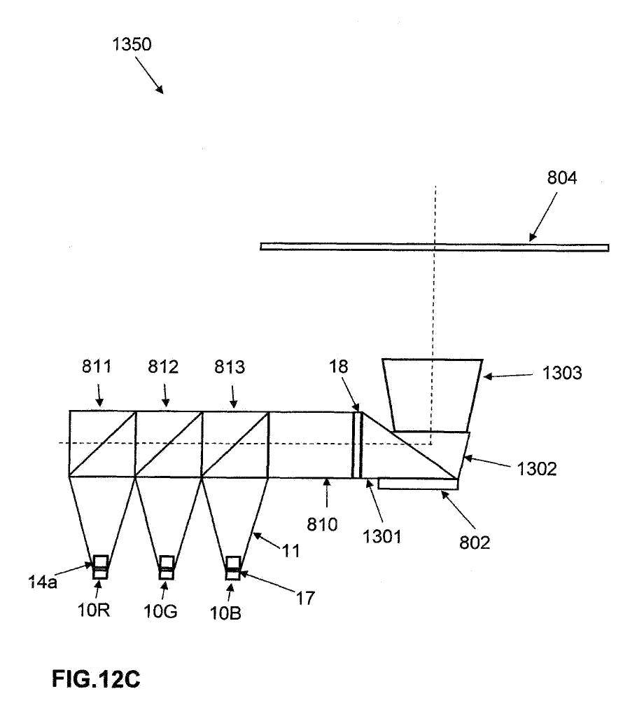

FIGS. 12A, 12B and 12C show cross-sectional views of projection systems 1150, 1250 and 1350 that utilize a single reflective micro-display 802 such as the digital mirror display made by Texas Instruments, Inc. As shown in FIGS. 12A-12C, projection systems 1150, 1250 and 1350 include an optional straight light pipe/tunnel 810 and an optional plate 18 to control light distribution and/or color mixing.

Lenses 801a, and 801b of FIGS. 12A-12B are relay lenses and each can consist of one or more lenses. Projection lens 803 and 1303 projects received images onto screen 804. Micro-display 802 can be illuminated by a white LED (FIG. 12A) or various LEDs with different colors, preferably, red 10R, green 10G and blue 10B (FIGS. 12B-12C). As shown in FIGS. 12B-12C, dichroic prisms 811, 812 and 813 are used to combine the three colors. It is possible to replace dichroic prism 811 with a mirror.

Total internal reflection (TIR) prisms 1301 and 1302 are used in projection system 1350 of FIG. 12C.

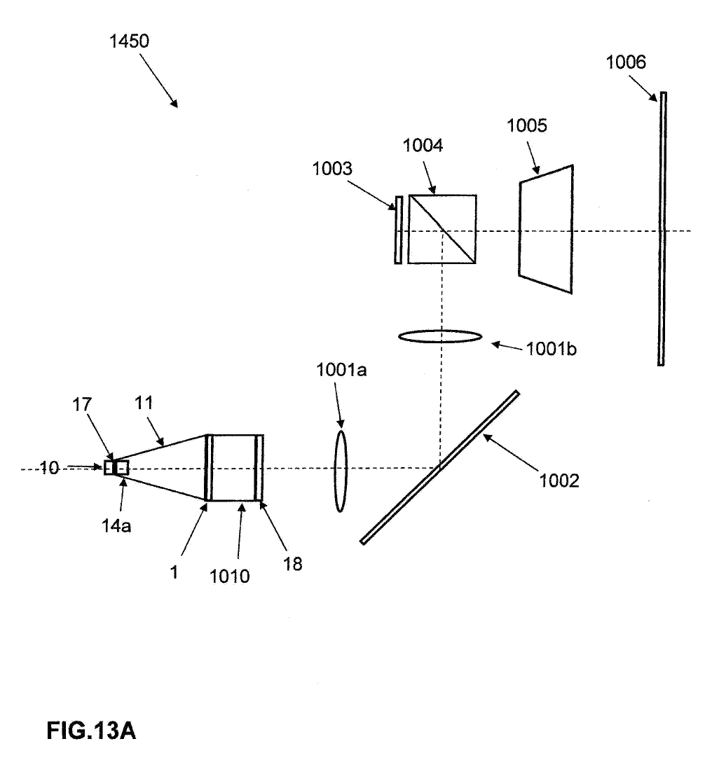

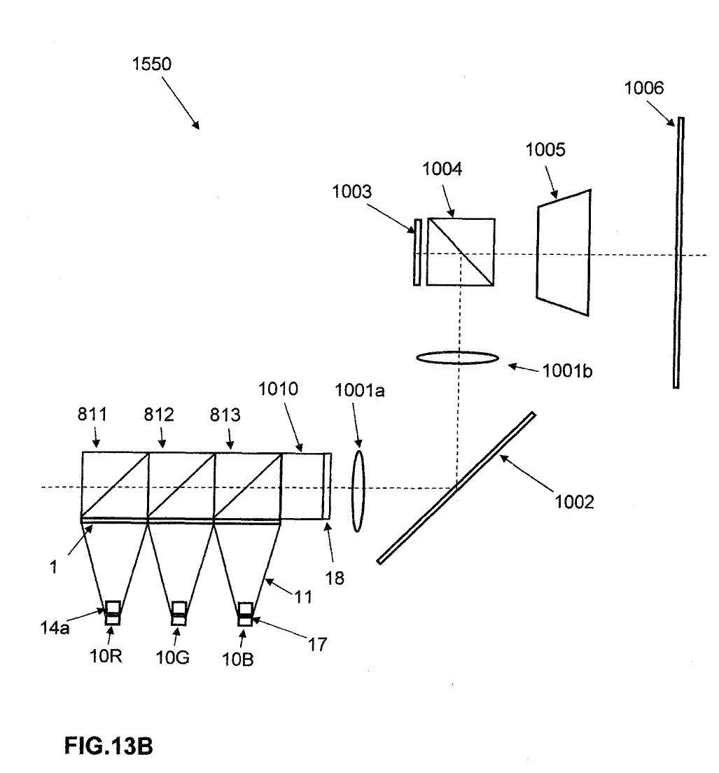

FIGS. 13A and 13B show cross-sectional views of projection systems 1450 and 1550 that utilize a single reflective liquid crystal on silicon (LCOS) micro-display 1003. Since this type of micro-display 1003 requires polarized light, a polarizer 1 is used at the exit aperture of the light tunnel 11. An optional straight light pipe/tunnel 1010, an optional plate 18, a mirror 1002, relay lenses 1001a and 1001b, a PBS cube 1004, a projection lens 1005 and a screen 1006 are utilized in these systems 1450 and 1550.

When a liquid crystal display (LCD) panel is used in projection systems 550, 650, 750, 850, 950, 1050, 1450 and 1550, two additional components, polarizer and analyzer, need to be inserted before and after the LCD panel, respectively. Projection systems 550, 650, 750, 850, 950, 1050, 1150, 1250, 1350, 1450 and 1550 can use illumination systems 100a, 100b, 100c, 100d, 100e, 100f, 200a, 200b, 200c, 200d, 300a, 300b, 300c, 300d, 300e, and 300f of FIGS. 2-5 as well as variations of such illumination systems 100a, 100b, 100c, 100d, 100e, 100f, 200a, 200b, 200c, 200d, 300a, 300b, 300c, 300d, 300e, and 300f.

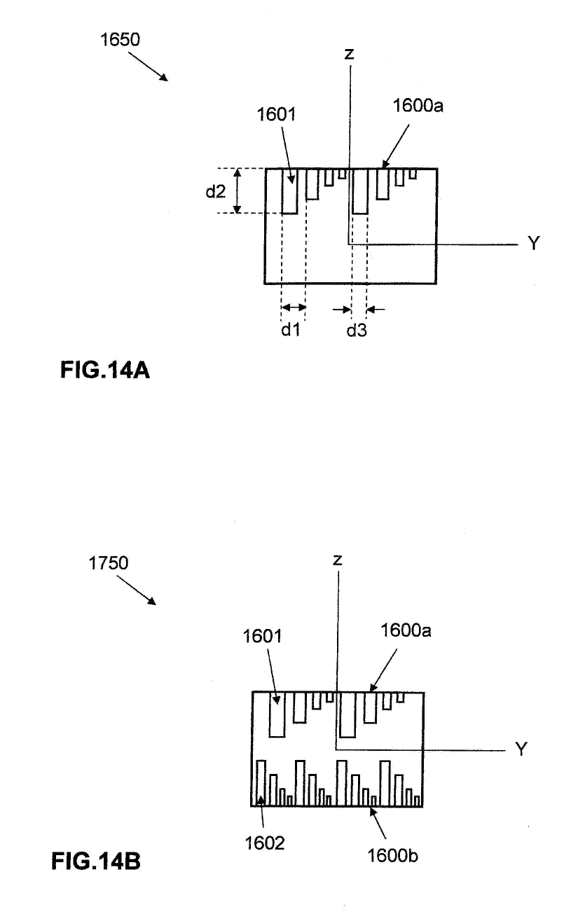

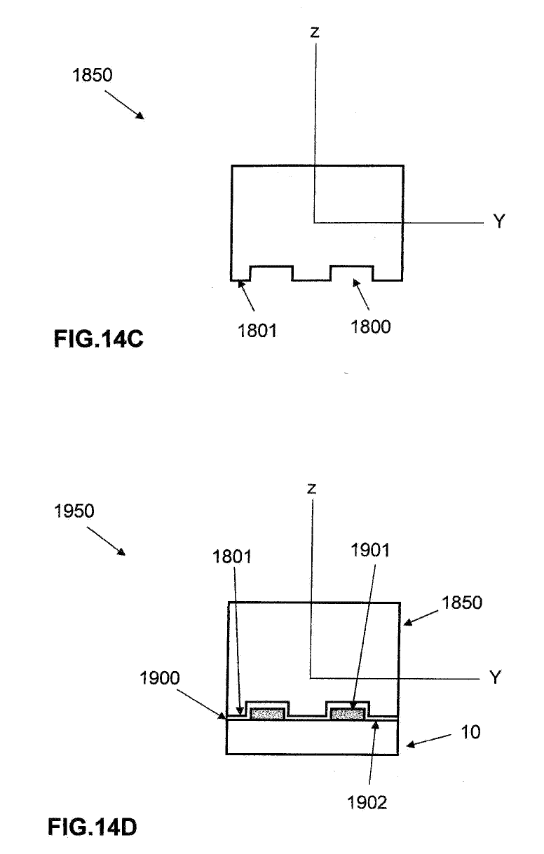

FIGS. 14A and 14B show cross-sectional views of extraction optical elements 1650 and 1750 that utilize three dimensional photonic crystal 1600a and 1600b on at least one of its top and bottom surfaces. The three dimensional photonic crystal 1600a and 1600b provides a variable change in the refractive index of the extraction optical elements 1650 and 1750 especially in the normal direction (i.e. z direction) leading to higher extraction efficiency of light generated within the associated LED. The three dimensional photonic crystal 1600a and 1600b can be either on top, bottom or both (top and bottom) surfaces of extraction optical elements 1650 and 1750. The three dimensional photonic crystal 1600a and 1600b can be applied to other types of extraction optical elements such as these shown in FIG. 3. The three dimensional photonic crystals 1600a and 1600b can have various opening 1601 and 1602 sizes in terms of separation, depth and diameter. The openings 1601 and 1602 are patterned in a single step and then etched in another step. Since the openings 1601 and 1602 have various diameters, their etch rate and depth will be different.

The depth, diameter and the spacing d₁ between nearest neighbors of openings 1601 and 1602 can vary from tens to thousands of nanometers. Openings 1601 and 1602 can have circular, square, hexagonal, or other cross sections. In some cases, spacing d₁ between nearest neighbors varies between about 0.1λ and about 10λ, preferably between about 0.1λ and about 5λ, where λ is the wavelength in the device of light emitted by the active region, depth d₂ of openings 1601 and 1602 varies between zero and hundreds of nanometers, and diameter d₃ of openings 1601 and 1602 varies between about 0.01λ and about 5λ. Openings 1601 and 1602 can have a refractive index of one (i.e., representing vacuum or air) or filled with a dielectric material (e.g., epoxy, adhesive, or silicon oxide) having a refractive index n of more than one. Parameters d₁, d₂, d₃, n as well as refractive index and shape of extraction optical elements 1650 and 1750 are usually selected to enhance the extraction efficiency from the LED and can be selected to preferentially emit light in a chosen direction.

FIG. 14C shows a cross-sectional view of an extraction optical element 1850 that have cavities 1800 made in its bottom surface 1801. As shown in FIG. 14D, these cavities 1800 allow the attachment of extraction optical element 1850 to LED 10 while maintaining a small gap 1900 (or a zero gap) between the bottom surface 1801 of extraction optical element 1850 and top surface 1902 of LED 10. The cavities 1800 are made so that they can enclose the metal pattern 1901 that exists on the top surface 1902 of an LED 10. If the LEDs have no metal layers on their top surfaces, there will be no need for cavities 1800 made in the bottom surface 1801 of extraction optical element 1850. The size of the gap 1900 (in the z-direction) is preferably no greater than one quarter of the LED light vacuum wavelength divided by the refractive index of the LED 10 material, thus, allowing light generated within LED 10 to enter extraction optical element 1850 without experiencing total internal reflection due to the refractive index difference between the refractive index of the gap 1900 material (e.g., air, epoxy, or optical adhesive) and refractive index of LED 10 material.

The extraction optical elements 1650, 1750 and 1850 can either be bonded directly to the top 1902 surface of LED 10 using a suitable semiconductor-to-semiconductor wafer bonding technique to form an optically transparent interface or bonded via an optical layer (e.g. epoxy or adhesive layer). The cavities 1800 and/or the photonic crystals 1600a and 1600b can be applied to other types of extraction optical elements such as these shown in FIG. 3. The refractive index of extraction optical elements 1650, 1750 and 1850 ranges between 1 and 3.5 and can be larger than that of the LED 10 material.

The illumination and projection systems disclosed herein can utilize LEDs of various materials systems, which include organic semiconductor materials, silicon as well as III-V systems such as III-nitride, III-phosphide, and III-arsenide, and II-VI systems. Examples of LED light-generating materials include InGaAsP, AlInGaN, AlGaAs, and InGaAlP. Organic light-emitting materials include small molecules such as aluminum tris-8-hydroxyquinoline (Alq₃) and conjugated polymers such as poly[2-methoxy-5-(2-ethylhexyloxy)-1,4-vinylenephenylene] or MEH-PPV. In addition, the illumination and projection systems disclosed herein can utilize LEDs that have both contacts formed on the same side of the device (which include, for example, flip-chip and epitaxy-up devices) or devices that have their contacts formed on opposite sides.

Other embodiments and modifications of the invention will readily occur to those of ordinary skill in the art in view of the foregoing teachings. Thus, the above summary and detailed description is illustrative and not restrictive. The invention is to be limited only by the following claims, which include all such embodiments and modifications when viewed in conjunction with the above specification and accompanying drawings. The scope of the invention should, therefore, not be limited to the above summary and detailed description, but should instead be determined by the appended claims along with their full scope of equivalents.

What is claimed is:

1. An illumination system, comprising:
a light emitting diode (LED); and
an extraction optical element, mounted to the LED for receiving light emitted from the LED, having a refractive index that matches the refractive index of the LED.

2. The illumination system of claim 1, wherein the refractive index of the extraction optical element ranges between 1.4 and 3.5.

3. The illumination system of claim 1, wherein the extraction optical element is bonded to the LED with an optically transparent adhesive layer.

4. The illumination system of claim 1, further comprising:
a tapered hollow light pipe receiving light output from the extraction optical element.

5. The illumination system of claim 1, further comprising:
a tapered solid light pipe receiving light output from the extraction optical element.

6. The illumination system of claim 1, further comprising a collimating lens.

7. The illumination system of claim 1, further comprising a tapered light tunnel configured to form a cavity around the extraction optical element.

8. The illumination system of claim 1, further comprising a wavelength converting layer formed between the LED and the extraction optical element.

9. The illumination system of claim 1, further comprising a polarization layer formed between the LED and the extraction optical element.

10. The illumination system of claim 1, wherein the extraction optical element includes an optically transmissive square body and an optical micro-element plate in optical communication with the square body.

11. The illumination system of claim 1, wherein the extraction optical element includes:
a diffusive layer;
a lens; and
an optically transmissive body between the lens and the diffusive layer.

12. The illumination system of claim 1, wherein the extraction optical element includes:
a lens; and
a diffusive layer formed on the lens.

13. An illumination system, comprising:
a light emitting diode (LED); and
an extraction optical element configured to received light emitted from the LED; and
a refractive index matching layer formed between the extraction optical element and the LED.

14. The illumination system of claim 13, wherein the refractive index of the refractive index matching layer ranges between 1.4 and 3.5.

15. The illumination system of claim 13, wherein the extraction optical element includes an optically transmissive square body and an optical micro-element plate in optical communication with the square body.

16. The illumination system of claim 13, wherein the extraction optical element includes:
a diffusive layer;
a lens; and
an optically transmissive body between the lens and the diffusive layer.

17. The illumination system of claim 13, wherein the extraction optical element includes:
a lens; and
a diffusive layer formed on the lens.

18. The illumination system of claim 13, further comprising a tapered light tunnel configured to form a cavity around the extraction optical element.

19. The illumination system of claim 13, further comprising a wavelength converting layer formed between the LED and the extraction optical element.

20. The illumination system of claim 13, further comprising a polarization layer formed between the LED and the extraction optical element.
